(19) United States
(12) Patent Application Publication
(10) Pub. No.: US 2011/0149069 A1
(43) Pub. Date: Jun. 23, 2011

(54) IMAGE PROCESSING APPARATUS AND CONTROL METHOD THEREOF

(75) Inventor: Kazunori Ishii, Yokohama-shi (JP)

(73) Assignee: CANON KABUSHIKI KAISHA, Tokyo (JP)

(21) Appl. No.: 12/964,239

(22) Filed: Dec. 9, 2010

(30) Foreign Application Priority Data
Dec. 22, 2009 (JP) 2009-291409

(51) Int. Cl. H04N 7/18; G06K 9/00

(52) U.S. Cl. 348/135; 382/103; 348/E07.085

(57) ABSTRACT

In one image included in a moving image, a specific area is registered as a reference area, and a feature amount of the reference area is set based on the saturation and hue distributions of pixels in the reference area. At this time, when a value calculated from the saturations in the reference area is equal to or smaller than a threshold, the feature amount is set to have a lower resolution of the hue distributions in the reference area than a case in which the value is larger than the threshold. By deciding a position corresponding to the feature amount of the reference area in a frame image after the image including the reference area by a matching process, the reference area is tracked. Then, an object in a specific area can be stably tracked in a moving image.

### BACKGROUND OF THE INVENTION

1. Field of the Invention

The present invention relates to a technique for tracking an object in a specific area in a moving image.

2. Description of the Related Art

Conventionally, in an image processing apparatus such as a digital camera or digital video camera, a technique for tracking an object set by a photographer or an object pattern which is set in advance in a captured moving image by means of an image process is known. In such an object tracking technique based on the image process, a position having a high correlation with the object pattern in an image is determined as a moved position of the object. For this reason, when an imaging range includes an analogous pattern, or when a new analogous pattern enters the imaging range, the object may fail to be recognized.

Japanese Patent Laid-Open No. 11-150676 discloses a technique which detects a moved position of an object by calculating a degree of correlation in a search area using a color-difference histogram of an object to be tracked as a template, and directs a camera in the direction of the object, thereby improving the tracking performance.

However, when the degree of correlation is determined using a set color difference signal pattern (feature amount) of the object as in the related art, the feature amount often changes due to a change in imaging condition, and a wrong object may be tracked or it becomes impossible to track any object. For example, when the set feature amount of the object includes a hue range, and the object has low saturation, if the brightness of the object changes depending on an illumination condition, the feature amount distribution also changes, and extraction of a high-correlation area often fails.

### SUMMARY OF THE INVENTION

The present invention has been made in consideration of the aforementioned conventional problems. The present invention provides a technique that allows an image processing apparatus to stably track an object in a specific area in a moving image.

According to one aspect of the present invention, there is provided an image processing apparatus comprising: area registration unit configured to register a specific area of an image included in a moving image as a reference area; detection unit configured to detect saturations and hues of respective pixels in the reference area; setting unit configured to set a feature amount of the reference area based on distributions of the saturations and hues, wherein when a value calculated from the saturations in the reference area is not more than a threshold, the setting unit sets the feature amount by setting a lower resolution of the distributions of the hues in the reference area than a case in which the value is larger than the threshold; and tracking unit configured to track the reference area by executing a matching process using the feature amount in an image of a frame after the image including the reference area.

Further features of the present invention will become apparent from the following description of exemplary embodiments (with reference to the attached drawings).

### BRIEF DESCRIPTION OF THE DRAWINGS

FIG. 1 is a block diagram showing the functional arrangement of a digital video camera according to an embodiment;

FIG. 2 is a flowchart of a tracking control process according to the embodiment;

FIG. 3 is a flowchart of a feature amount extraction process according to the first embodiment;

FIGS. 4A and 4B are flowcharts of a feature amount extraction process according to the second embodiment;

FIG. 5 is a view for explaining a color-difference feature space; and

FIGS. 6A and 6B are graphs for explaining hue histograms.

### DESCRIPTION OF THE EMBODIMENTS

### First Embodiment

An embodiment of the present invention will be described in detail hereinafter with reference to the drawings. Note that one embodiment to be described hereinafter will describe an example in which the present invention is applied to a digital video camera, as an example of an image processing apparatus, which can track a specific area of an object image. However, the present invention is applicable to an arbitrary device that can track a specific area of an object image as a moving image.

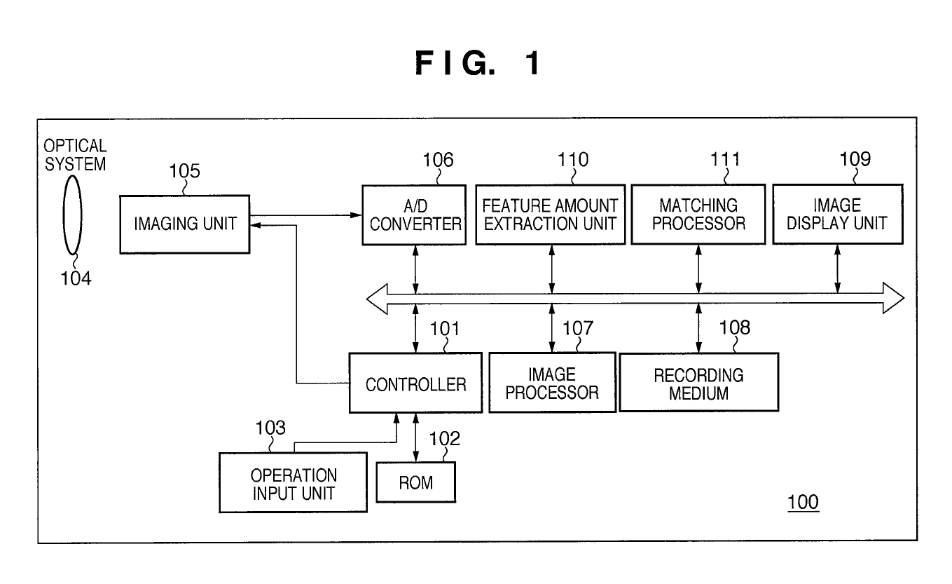

FIG. 1 is a block diagram showing the functional arrangement of a digital video camera 100 according to the first embodiment of the present invention.

A controller 101 is, for example, a CPU, which controls operations of respective blocks of the digital video camera 100 by mapping and executing operation programs of the respective blocks of the digital video camera 100, which are stored in a ROM 102, on a RAM (not shown). The ROM 102 is a non-volatile memory, which stores, for example, parameters required for the operations of the respective blocks of the digital video camera 100, and various settings of the digital video camera 100, in addition to the operation programs of the respective blocks of the digital video camera 100. An operation input unit 103 is a user interface (for example, a menu button and imaging button), which is included in the digital video camera 100 and accepts user's operations. The operation input unit 103 transfers information corresponding to the accepted operation to the controller 101. An example will be described below wherein the digital video camera 100 of this embodiment uses a touch panel type display device as an image display unit 109 (to be described later). The operation input unit 103 also acquires position information on a display area of the image display unit 109 where a touch input is detected by a touch sensor, and also transfers that information to the controller 101.

An imaging unit 105 includes, for example, an image sensor such as a CCD or CMOS sensor. The imaging unit 105 photoelectrically converts an object image formed on the image sensor by an optical system 104, and sequentially outputs an obtained analog image signal to an A/D converter 106. The optical system 104 is a lens group that is configured by a fixed lens, zoom lens, and focus lens, and is included in the digital video camera 100. The optical system 104 forms an image of reflected light of an object on the imaging unit 105. The A/D converter 106 applies A/D conversion to the input analog image signal to obtain a digital image signal (image data), and outputs the digital image signal to an image processor 107. The A/D converter 106 includes, for example, a CDS/AGC circuit, and performs gain adjustment of the digital image signal. The image processor 107 applies various image processes to the digital image signal input from the A/D converter 106 to generate a video signal. The image processor 107 encodes the video signal according to an encoding method and parameters, which are set in accordance with information of a video output format stored in, for example, the ROM 102, and outputs the encoded video signal to a recording medium 108. The image processor 107 converts the input image data on an RGB color space into that on a YCbCr color space, and outputs that image data to a feature amount extraction unit 110 and matching processor 111 (to be described later).

The recording medium 108 includes, for example, a built-in memory included in the digital video camera 100, and a storage device such as a memory card or HDD, which is detachably attached to the digital video camera 100. The recording medium 108 records video data encoded by the image processor 107. The image display unit 109 is, for example, a display device such as a compact LCD included in the digital video camera 100. The image display unit 109 displays video data stored in the recording medium 108. The image display unit 109 serves as an electronic viewfinder by sequentially displaying (through-displaying) image data output from the A/D converter 106.

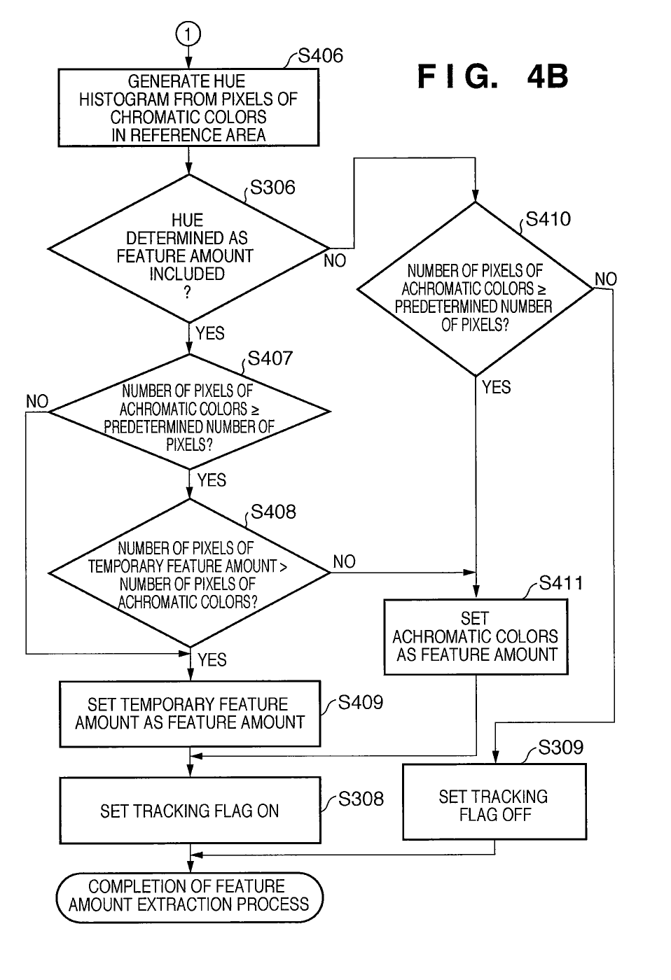

The feature amount extraction unit 110 is a block which analyzes a designated reference area of the image data on the YCbCr color space, which is output from the A/D converter 106, and extracts a feature amount as a distribution of color information of an image in the reference area. The feature amount is stored in, for example, the RAM, and is used in a matching process (to be described later). The matching processor 111 executes a matching process for searching for an area that analogizes the feature amount from image data captured after the image data in which the feature amount is extracted. Assume that since the matching process uses hue (H) information and saturation (S) information from a color-difference feature space of Cb and Cr shown in FIG. 5, the feature amount also includes hue information and saturation information. Using hue information and saturation information, the matching process can be executed by excluding luminance information which tends to be changed depending on, for example, illumination conditions.

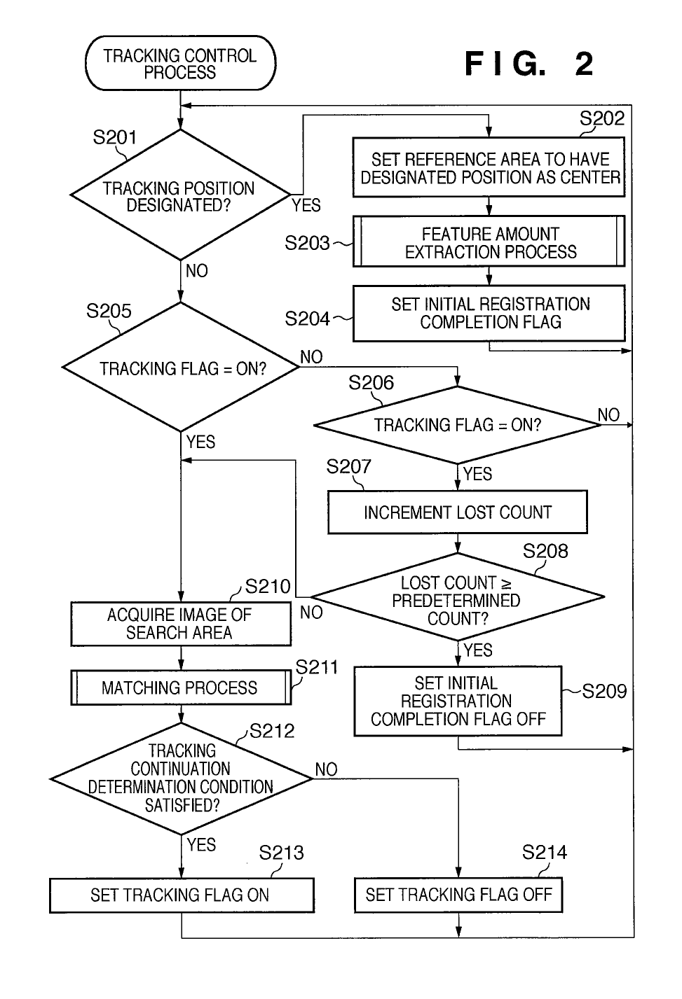

A tracking control process of the digital video camera 100 of this embodiment with the aforementioned arrangement will be described below further using the flowchart shown in FIG. 2. Note that the tracking control process is a loop process executed every time a frame is captured in a state in which the power supply of the digital video camera 100 is ON and the image display unit 109 starts a through-display operation.

The controller 101 determines in step S201 if the user makes an input that designates a position of an object to be tracked in an image to the operation input unit 103. Assume that information of the position of the object to be tracked in the image is transferred from the operation input unit 103 to the controller 101 by detecting, for example, a user's touch input on the display area of the image display unit 109 by the touch sensor. The controller 101 stores the input information of the position of the object to be tracked in the image in the RAM as information of a tracking position. If the user makes the input that designates the position of the object to be tracked in the image, the controller 101 advances the process to step S202; otherwise, it advances the process to step S205.

In step S202, the controller 101 sets, to have the designated tracking position as the center, a reference area according to information of the size of an area to be set as the reference area, which is stored in, for example, the ROM 102. The controller 101 acquires hue information and saturation information of the reference area for each pixel and stores them in the RAM. Note that if an area outside image data is included when the size of the area to be set as the reference area is set to have the designated tracking position as the center, the reference area may be set to fall within the image data.

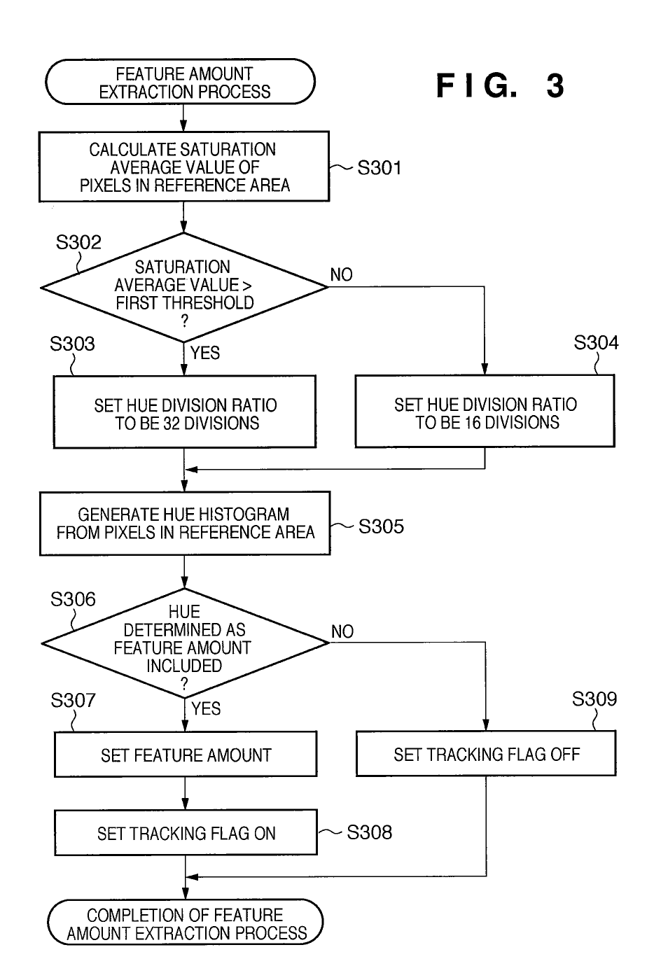

In step S203, the controller 101 transfers information of the reference area to the feature amount extraction unit 110, and controls the feature amount extraction unit 110 to execute a feature amount extraction process, thus extracting a feature amount of the reference area. The feature amount extraction process executed by the feature amount extraction unit 110 will be described in detail below using the flowchart shown in FIG. 3. Assume that the controller 101 reads out, from the ROM 102, information such as a threshold value and the number of divisions of hues which are referred to in the feature amount extraction process, and transfers the readout information to the feature amount extraction unit 110.

In step S301, the feature amount extraction unit 110 calculates a saturation average value of pixels in the reference area using pieces of saturation information of all the pixels in the input reference area. At this time, the feature amount extraction unit 110 determines if the saturation average value is larger than a first threshold, which is decided in advance as a saturation value used to determine low saturation (S302). If the saturation average value is larger than the first threshold, the feature amount extraction unit 110 advances the process to step S303; otherwise, it advances the process to step S304.

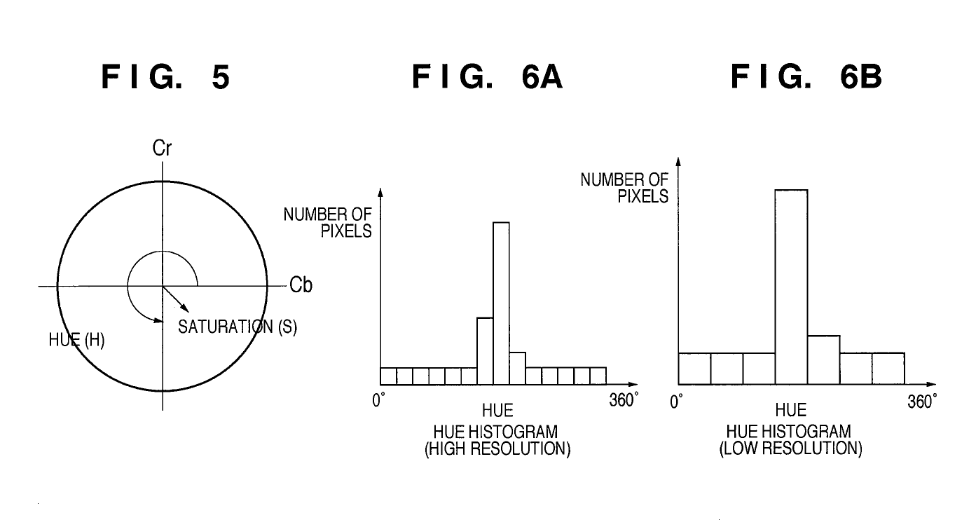

In step S303, the feature amount extraction unit 110 sets the number of divisions as a hue resolution to be, for example, “32” as a high resolution. Hues range from 0° to 360°, as shown in FIG. 5, and this embodiment expresses the number of divisions of hues to which pixels in the reference area are to be classified as “hue resolution”. Likewise, in step S304 the feature amount extraction unit 110 sets the hue resolution to be, for example, “16” as a low resolution. By setting the hue resolution in this way, histograms can be generated by classifying the pixels in the reference area by means of the numbers of pixels for respective hue ranges, as shown in FIGS. 6A and 6B (S305). That is, since it is considered that hues suffer a small influence of a change in brightness when saturation is sufficiently high in the reference area, the feature amount can be set to have a high resolution, as shown in FIG. 6A, so as to avoid misrecognition with an analogous color. Since it is considered that a hue change tends to take place due to a change in brightness when saturation is low in the reference area, the feature amount can be set to have a low resolution, as shown in FIG. 6B, so as to allow tracking even when hues change slightly. That is, when it is determined that an object includes many low-saturation pixels in the reference area, redundancy can be provided to the tracking performance so as to allow tracking even when slight hue changes take place, by reducing the number of divisions of hues, thus implementing stable tracking.

The feature amount extraction unit 110 determines in step S306 if the histogram generated in step S305 includes hues of pixels, the number of which is equal to or larger than the pre-set number of pixels required to determine them as a feature amount. Note that in this embodiment, since the reference area has a predetermined size, the number of pixels required to determine hues as a feature amount assumes a value set with respect to the predetermined number of pixels of the reference area. However, for example, when the user can set the reference area having an arbitrary size, the number of pixels required to determine hues as a feature amount may be set to be the number of pixels corresponding to a predetermined ratio of the number of pixels of the set reference area. If the histogram includes hues of pixels, the number of which is equal to or larger than the number of pixels required to determine them as a feature amount, the feature amount extraction unit 110 advances the process to step S307; otherwise, it advances the process to step S309.

In step S307, the feature amount extraction unit 110 sets information of the hues of pixels, the number of which is equal to or larger than the number of pixels required to determine them as a feature amount in the reference area, and pixels of these hues as a feature amount, and outputs the feature amount to the controller 101. The controller 101 stores information of the feature amount in the RAM. In step S308, the feature amount extraction unit 110 outputs information indicating that tracking is allowed to the controller 101, and the controller 101 sets a tracking flag which is stored in the RAM and indicates to allow tracking to be ON.

On the other hand, if it is determined in step S306 that the histogram does not include hues of pixels, the number of which is equal to or larger than the number of pixels required to determine them as a feature amount, the feature amount extraction unit 110 outputs information indicating that it is impossible to track any object to the controller 101, and the controller 101 sets the tracking flag stored in the RAM to be OFF.

Note that even when it is determined in step S302 that the saturation average value is higher than the first threshold, and it is determined in step S306 that the hues of pixels, the number of which is equal to or larger than the number of pixels required to determine them as a feature amount, are not included, the feature amount extraction unit 110 does not execute a process for extracting a feature amount by lowering the hue resolution. This is because lowering the resolution of the feature amount may cause misrecognition of an analogous color and may disturb continuation of stable tracking of an object as the primary object.

After completion of the feature amount extraction process, the controller 101 advances the process to step S204 of the tracking control process in this way. If the tracking flag is ON, the controller 101 sets an initial registration completion flag, which is stored in the RAM and indicates that the feature amount has already been registered, to be ON. Upon completion of the process in step S204, the controller 101 returns the process to step S201. Assume that the pieces of information of the tracking flag and initial registration completion flag are set to be OFF at the time of activation of the digital video camera 100.

The controller 101 determines in step S205 if the tracking flag stored in the RAM is ON. If the tracking flag is ON, the controller 101 advances the process to step S210.

In a state in which the tracking flag is ON, that is, the reference area and feature amount are registered, and if it is further determined that the reference is allowed to be tracked, the controller 101 extracts image data of a search area from newly captured image data (S210). The search area is a search range which has, as the center, the position set as the center of the reference area in the image captured in the previous frame (the position identified that the feature amount is moved), is set in advance in the ROM 102, and is larger than the reference area, and moves for each frame. That is, in the next frame after the feature amount is extracted, the search range having the tracking position input in step S201 as the center is set. However, in the subsequent frames, a search range is set to have, as the center, a position to which a newly identified reference area has moved. The controller 101 transfers the obtained image data of the search area to the matching processor 111, and advances the process to step S211.

In step S211, the controller 101 transfers the feature amount and information of the position set as the center of the reference area in the image captured in the previous frame to the matching processor 111, and controls the matching processor 111 to execute a matching process. The matching process is a process for searching the search area for an area having high correlation with the feature amount of the reference area, and identifying a moved position of the reference area, and can use a known process. For example, using, as a template, an image obtained by binarizing the image of the reference area to pixels which correspond to the feature amount and those which do not correspond to the feature amount, a position having a highest degree of correlation with the template in the search area is identified as a moved position of the reference area. That is, the moved position of the reference area is used as the central position of the search area in the next frame.

Note that the aforementioned matching process is an example and, for example, the process may be executed as follows. This embodiment has explained the method of using an image of the reference area decided based on a point that is initially registered as the tracking position in the matching process. However, an image used in the matching process may be updated for each frame. That is, an image having the same size as a reference area at a position identified as the moved position of the reference area as a result of the matching process may be updated as an image of the reference area used in a new matching process. Alternatively, the matching process may be executed with reference to the hue histogram decided as the feature amount. That is, a degree of correlation may be identified based on the similarity of an occupation ratio of hues decided as the feature amount in an area having the same size as the extracted reference area in the search area.

The controller 101 determines in step S212 if the matching process result satisfies a tracking continuation determination condition. More specifically, as a result of the matching process, if the degree of correlation of the feature amount at a position identified as the moved position of the reference area is smaller than the degree of correlation which is set in advance in the ROM 102 and allows to continue tracking, the controller 101 determines that it is impossible to continue tracking, and advances the process to step S214. In step S214, the controller 101 sets the tracking flag to be OFF, and returns the process to step S201. On the other hand, as a result of the matching process, if the degree of correlation of the feature amount at the position identified as the moved position of the reference area is equal to or higher than the degree of correlation which allows to continue tracking, the controller 101 determines that it is possible to continue tracking, and advances the process to step S213. In step S213, the controller 101 sets the tracking flag to be ON, and returns the process to step S201.

If it is determined in step S205 that the tracking flag is OFF, that is, the reference area and the feature amount are not registered, or if it is determined as a result of the matching process executed for the previous frame that it is impossible to continue tracking, the controller 101 advances the process to step S206. The controller 101 determines in step S206 if the initial registration completion flag stored in the RAM is ON. If the initial registration completion flag is ON, the controller 101 advances the process to step S207; otherwise, it returns the process to step S201.

In step S207, the controller 101 determines a state (lost) in which an area that matches the reference area cannot be found in the matching process of the previous frame, and increments a lost count stored in the RAM by “1”. Then, the controller 101 determines in step S208 if the lost count is equal to or larger than a count value which is stored in the ROM 102 and is used to determine an unrecoverable tracking state. If the lost count is larger than the count used to determine an unrecoverable tracking state, the controller 101 advances the process to step S209; otherwise, it advances the process to step S210. Note that information of a search area set in step S210 at that time has, as the center, the moved position of the reference area finally identified by the matching process. Also, since a moving amount of an object in the reference area is likely to increase during the lost state, a search area may be expanded depending on the value of the lost count.

In step S209, the controller 101 sets the initial registration completion flag stored in the RAM to be OFF, and clears information of the reference area stored in the RAM. The controller 101 then returns the process to step S201 to repeat the tracking control process.

Note that this embodiment decides the hue resolution by comparing the saturation average value of the reference area with the first threshold. However, the present invention is not limited to such specific resolution decision method. For example, the resolution may be decided based on the number of pixels included in a saturation range lower than the first threshold in the reference area. With either method, a lower hue resolution is set with decreasing saturation average value of the reference area.

As described above, the image processing apparatus of this embodiment can track an image in a specific area in a moving image. More specifically, in an image included in a moving image, a specific area is registered as a reference area, and a feature amount of the reference area is set based on saturation and hue distributions of pixels in the reference area. At this time, when the saturation average value in the reference area is equal to or smaller than the threshold, the feature amount is set to have a lower resolution of the hue distribution in the reference area than a case in which the saturation average value is larger than the threshold. Then, in an image of a frame after the image including the reference area, a position corresponding to the feature amount of the reference area is decided by the matching process, thereby tracking the reference area.

In this way, under an imaging environment which suffers a change in brightness, the reference area can be stably tracked. That is, when the reference area includes many high-saturation objects, a high hue resolution is set to avoid an analogous color from being erroneously tracked. When the reference area includes many low-saturation objects, a low hue resolution is set to provide redundancy to the tracking performance even when brightness changes, thus avoiding a state in which it is impossible to track any object or a wrong object is tracked.

### Second Embodiment

Another embodiment of the present invention will be described below. The aforementioned first embodiment has explained the method of deciding the resolution of a hue distribution based on a saturation value, and setting, as a feature amount of a reference area, the hues of pixels, the number of which is equal to or larger than the pre-set number of pixels required to determine them as a feature amount. The second embodiment can further eliminate tracking errors by setting a saturation range to be set as a feature amount. Note that in this embodiment, “chromatic color” indicates colors within a saturation range set as a feature amount, “achromatic color” indicates colors within a saturation range lower than that set as the feature amount, and they are different from their original definitions.

A digital video camera of the second embodiment has the same arrangement as that of the aforementioned first embodiment, and executes the same tracking control process. Hence, a description of the functional arrangement and tracking control process will not be repeated.

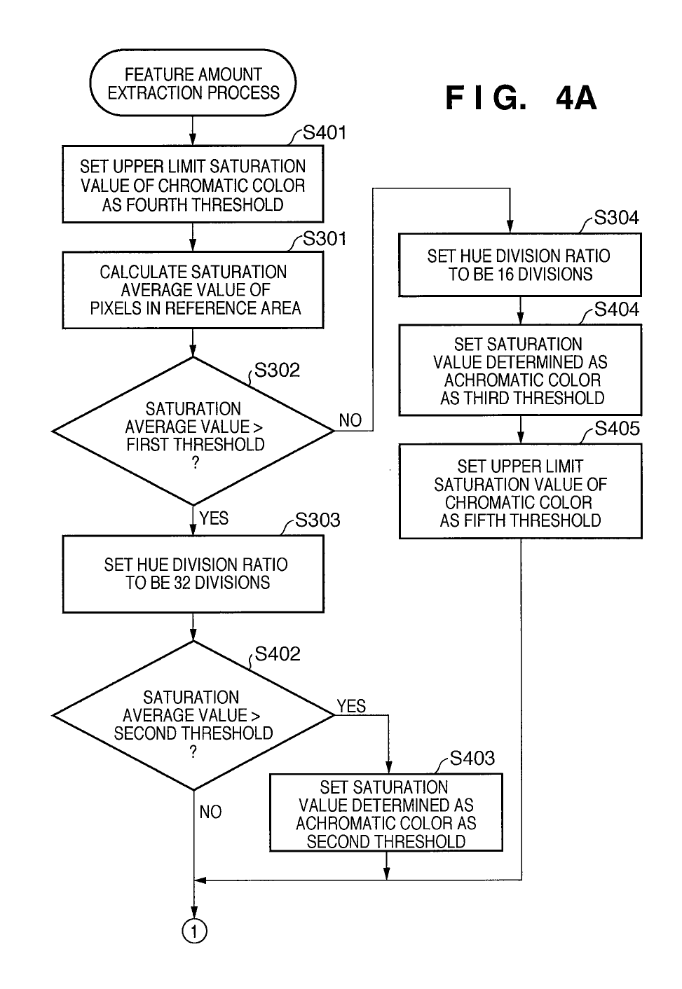

A feature amount extraction process of a digital video camera 100 of this embodiment will be described in detail below using the flowchart shown in FIGS. 4A and 4B. Note that in this feature amount extraction process, the same step numbers denote steps that execute the same processes as in the first embodiment, a description thereof will not be repeated, and only steps as a characteristic feature of this embodiment will be described.

In step S401, a feature amount extraction unit 110 sets an upper limit value of a saturation range to be set as a feature amount to be a predetermined fourth threshold. Assume that pixels in a saturation range higher than the fourth threshold are determined to have non-feature chromatic colors, and are not used as the feature amount in this embodiment. Note that the fourth threshold may be a maximum saturation value, but it may be set to be an arbitrary value depending on the processing performance of the digital video camera 100.

The feature amount extraction unit 110 determines in step S402 if a saturation average value of pixels in a reference area is larger than a second threshold which is set in advance as a value that is larger than a first threshold and is smaller than the fourth threshold. If the saturation average value is larger than the second threshold, the feature amount extraction unit 110 advances the process to step S403 to set a lower limit value of the saturation range to be set as a feature amount to be the second threshold. If the saturation average value is equal to or smaller than the second threshold, the feature amount extraction unit 110 sets the lower limit value of the saturation range to be set as a feature amount to be the first threshold as a threshold used to determine low saturation in step S302.

If it is determined in step S302 that the saturation average value of pixels in the reference area is equal to or smaller than the first threshold, that is, the reference area has low saturation, in step S404 the feature amount extraction unit 110 sets a lower limit value of the saturation range to be set as a feature amount to be a third threshold smaller than the first threshold. In step S405, the feature amount extraction unit 110 changes an upper limit value of the saturation range to be set as a feature amount to a fifth threshold which is smaller than the fourth threshold and is larger than the second threshold.

That is, the feature amount extraction unit 110 sets a saturation range for setting a feature amount, that is, a range for determining chromatic colors, in accordance with the saturation average value of the reference area by the processes in steps S401 to S405. The magnitude relationship of the respective thresholds is the fourth threshold, fifth threshold, second threshold, first threshold, and third threshold in turn from larger ones, and the chromatic color range is set to be one of the following three ranges depending on the magnitude of the saturation average value:

(1) a range “equal to or larger than the second threshold” and “equal to or smaller than the fourth threshold”;

(2) a range “equal to or larger than the first threshold” and “equal to or smaller than the fourth threshold”; and

(3) a range “equal to or larger than the third threshold” and “equal to or smaller than the fifth threshold”.

In this way, a feature amount that can adequately catch a feature of the reference area (object) as a target to be tracked can be extracted.

In step S406, the feature amount extraction unit 110 generates a histogram by classifying pixels included in the chromatic color range of those of the reference area in accordance with a hue resolution set in step S303 or S304. The feature amount extraction unit 110 determines in step S306 if the generated histogram includes hues of pixels, the number of which is equal to or larger than the pre-set number of pixels required to determine them as a feature amount. If the histogram includes hues of pixels, the number of which is equal to or larger than the number of pixels required to determine them as a feature amount, the feature amount extraction unit 110 temporarily stores information of the hues of pixels, the number of which is equal to or larger than the number of pixels required to determine them as a feature amount, and the number of pixels of these hues as a temporary feature amount, and advances the process to step S407. If the histogram does not include hues of pixels, the number of which is equal to or larger than the number of pixels required to determine them as a feature amount, the feature amount extraction unit 110 advances the process to step S410.

The feature amount extraction unit 110 determines in step S407 if the number of pixels having saturation values, which are classified into achromatic colors, of those of the reference area is larger than the number of pixels having achromatic colors which can be set as a feature amount. The number of pixels having achromatic colors which can be set as a feature amount may assume the same value as the number of pixels determined as a feature amount, or may assume a different value. If the number of pixels having saturation values which are classified into achromatic colors is equal to or larger than the number of pixels having achromatic colors which can be set as a feature amount, the feature amount extraction unit 110 advances the process to step S408; otherwise, it advances the process to step S409.

The feature amount extraction unit 110 determines in step S408 if the number of pixels having the hues set as the temporary feature amount in step S406 of those of the reference area is larger than the number of pixels having saturation values, which are classified into achromatic colors. If the number of pixels having the hues set as the temporary feature amount is larger than the number of pixels having saturation values, which are classified into achromatic colors, the feature amount extraction unit 110 advances the process to step S409; otherwise, it advances the process to step S411.

In step S409, the feature amount extraction unit 110 sets information of the hues set as the temporary feature amount and pixels of these hues as a feature amount, and outputs the set feature amount to a controller 101. Then, the controller 101 stores information of the feature amount in a RAM.

The feature amount extraction unit 110 determines in step S410 if the number of pixels having saturation values, which are classified into achromatic colors, of those of the reference area is larger than the number of pixels of achromatic colors which can be set as a feature amount, as in step S407. If the number of pixels having saturation values, which are classified into achromatic colors, is equal to or larger than the number of pixels of achromatic colors which can be set as a feature amount, the feature amount extraction unit 110 advances the process to step S411; otherwise, it advances the process to step S309.

In step S411, the feature amount extraction unit 110 sets information of hues of saturation values, which are classified into achromatic colors, and pixels of these hues as a feature amount, and outputs the set feature amount to the controller 101. Then, the controller 101 stores information of the feature amount in the RAM. In this way, even when pixels of the reference area do not include any hues of pixels, the number of which is equal to or larger than the number of pixels required to determine them as a feature amount, or even when the number of pixels having hues determined as a feature amount is smaller than the number of pixels having saturation values, which are classified into achromatic colors, information of pixels having saturation values, which are classified into achromatic colors, is set as a feature amount, thus allowing to track the reference area. However, as a pixel has a lower saturation value, its hue value tends to change due to a change in brightness. Hence, when information of pixels having saturation values, which are classified into achromatic colors, is set as a feature amount, a matching process in step S211 is susceptible to a change in brightness. For this reason, when information of pixels having saturation values, which are classified into achromatic colors, is set as a feature amount, a matching processor 111 sets a loose criterion required to determine the same feature amount as pixels corresponding to the feature amount of the reference area for pixels in a search area upon execution of the matching process.

As described above, the image processing apparatus of this embodiment can track an image in a specific area in a moving image. The image processing apparatus registers a specific area in an image included in a moving image as a reference area, and sets a feature amount of the reference area based on saturation and hue distributions of pixels in the reference area. More specifically, when the saturation average value in the reference area is equal to or smaller than the threshold, hues are classified to have a lower resolution of the hue distribution in the reference area than a case in which the saturation average value is larger than the threshold, and the hues of pixels in a distribution, the number of which is larger than the number of pixels required to determine a predetermined feature, are set as a feature amount.

Also, a saturation range for setting a feature amount is decided according to the saturation average value in the reference area. At this time, when the number of pixels having hues set as a feature amount is smaller than the number of pixels included in a saturation range lower than that for setting a feature amount, the hues of saturation values lower than the saturation range for setting a feature amount are changed as a feature amount.

When the saturation range for setting a feature amount does not include any hues of pixels in the distribution, the number of which is larger than the number of pixels determined as a predetermined feature, it is determined if the number of pixels included in the saturation range lower than that for setting a feature amount is larger than the predetermined number of pixels. At this time, the hues of pixels in the saturation range lower than that for setting a feature amount are set as a feature amount.

The position corresponding to the feature amount of the reference area is decided by the matching processing in an image of a frame after the image including the reference area using the feature amount decided in this way, thereby tracking the reference area.

In this way, under an imaging environment that suffers a change in brightness, the reference area can be stably tracked. That is, when the reference area includes many high-saturation objects, a high hue resolution is set to avoid an analogous color from being erroneously tracked. Furthermore, the saturation range of the feature amount is limited according to a value calculated from the saturation values of the reference area, thereby eliminating tracking errors. When the reference area includes many low-saturation objects, a low hue resolution is set to provide redundancy to the tracking performance even when brightness is changed, thus avoiding a state in which it is impossible to track any object or a wrong object is tracked.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-291409, filed Dec. 22, 2009, which is hereby incorporated by reference herein in its entirety.

What is claimed is:

1. An image processing apparatus comprising:
area registration unit configured to register a specific area of an image included in a moving image as a reference area;
detection unit configured to detect saturations and hues of respective pixels in the reference area;
setting unit configured to set a feature amount of the reference area based on distributions of the saturations and hues, wherein when a value calculated from the saturations in the reference area is not more than a threshold, said setting unit sets the feature amount by setting a lower resolution of the distributions of the hues in the reference area than a case in which the value is larger than the threshold; and
tracking unit configured to track the reference area by executing a matching process using the feature amount in an image of a frame after the image including the reference area.

2. An image processing apparatus further comprising:
area registration unit configured to register a specific area of an image included in a moving image as a reference area;
detection unit configured to detect saturations and hues of respective pixels in the reference area;
setting unit configured to set a feature amount of the reference area based on distributions of the saturations and hues, wherein said setting unit sets the feature amount by setting a lower resolution of the distributions of the hues in the reference area as a value calculated from the saturations in the reference area is lower; and
tracking unit configured to track the reference area by executing a matching process using the feature amount in an image of a frame after the image including the reference area.

3. The apparatus according to claim 1, wherein said setting unit sets, as the feature amount, a distribution of hues corresponding to the number of pixels, which is larger than the predetermined number of pixels, of the distributions of the hues.

4. The apparatus according to claim 1, wherein when the value calculated from the saturations in the reference area is larger than a predetermined first threshold, said setting unit sets the feature amount based on information of pixels of saturations within a range which is not less than the first threshold and is smaller than a fourth threshold larger than the first threshold.

5. The apparatus according to claim 4, wherein when the value calculated from the saturations in the reference area is larger than the first threshold, and is larger than a second threshold smaller than the fourth threshold, said setting unit sets the feature amount based on information of pixels of saturations within a range, which is not less than the second threshold and is smaller than the fourth threshold, of pixels in the reference area.

6. The apparatus according to claim 5, wherein when the value calculated from the saturations in the reference area is smaller than the first threshold, said setting unit sets the feature amount based on information of pixels of saturations within a range, which is not less than a third threshold smaller than the first threshold and is smaller than a fifth threshold smaller than the fourth threshold, of pixels in the reference area.

7. The apparatus according to claim 4, wherein when the number of pixels in the reference area, which have saturations smaller than a saturation range for setting the feature amount, is larger than the number of pixels as hues set as the feature amount, said setting unit sets, as the feature amount, the hues of the pixels having the saturations smaller than the saturation range.

8. The apparatus according to claim 4, wherein when a saturation range for setting the feature amount does not include any distribution of hues corresponding to the number of pixels, which is larger than the predetermined number of pixels, and when the number of pixels of pixels in the reference area, which have saturations smaller than the saturation range for setting the feature amount, is larger than the number of pixels which are not included in a predetermined saturation range, said setting unit sets, as the feature amount, hues of pixels having saturations smaller than the saturation range for setting the feature amount.

9. A control method of an image processing apparatus comprising:
an area registration step of registering a specific area of an image included in a moving image as a reference area;
a detection step of detecting saturations and hues of respective pixels in the reference area;
a setting step of setting a feature amount of the reference area based on distributions of the saturations and hues, wherein when a value calculated from the saturations in the reference area is not more than a threshold, the feature amount being set by setting a lower resolution of the distributions of the hues in the reference area than a case in which the value is larger than the threshold; and
a tracking step of tracking the reference area by executing a matching process using the feature amount in an image of a frame after the image including the reference area.

10. A control method of an image processing apparatus, comprising:
an area registration step of registering a specific area of an image included in a moving image as a reference area;
a detection step of detecting saturations and hues of respective pixels in the reference area;
a setting step of setting a feature amount of the reference area based on distributions of the saturations and hues, wherein the feature amount being set by setting a lower resolution of the distributions of the hues in the reference area as a value calculated from the saturations in the reference area is lower; and
a tracking step of tracking the reference area by executing a matching process using the feature amount in an image of a frame after the image including the reference area.
